(19) United States
(12) Patent Application Publication
(10) Pub. No.: US 2007/0178735 A1
(43) Pub. Date: Aug. 2, 2007

(54) UNIVERSAL SERIAL BUS CONNECTING DEVICE

(75) Inventor: Yarn-Chen Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: SUNPLUS TECHNOLOGY CO., LTD., Hsinchu (TW)

(21) Appl. No.: 11/554,041

(22) Filed: Oct. 30, 2006

Related U.S. Application Data
(62) Division of application No. 11/308,842, filed on May 15, 2006.

(30) Foreign Application Priority Data
Jan. 27, 2006 (TW) 95103381

(51) Int. Cl. H01R 29/00

(52) U.S. Cl. 439/172

(57) ABSTRACT

A universal serial bus connecting device is provided, including a first housing, a second housing, a connector, and second pins. The second housing, movably disposed at one side of the first housing, has a first opening located at one side of the second housing far from the first housing. The connector includes a substrate inserted in the second housing, and four first pins embedded in the substrate. The four second pins are disposed within the second housing. Each second pin is electrically connected to the corresponding first pin. When the connector is accommodated within the second housing, the connector and the second housing form a receptacle. When the second housing is moved to make the connector protrude from the first opening, the connector and the second housing form a plug.

### CROSS-REFERENCE TO RELATED APPLICATION

This is a divisional application of patent application Ser. No. 11/308,842, filed on May 15, 2006, which claims the priority benefit of Taiwan patent application serial no. 95103381, filed on Jan. 27, 2006 and is now pending. The entirety of each of the above-mentioned patent applications is hereby incorporated by reference herein and made a part of this specification.

### BACKGROUND OF THE INVENTION

1. Field of Invention

The present invention relates to a universal serial bus connecting device, and more particularly to a universal serial bus connecting device that can be selectively converted to a plug or a receptacle.

2. Description of Related Art

Previously, if a user wanted to externally connect a device to a computer, unless using an existing interface, the user had to additionally mount a corresponding interface card to act as a medium between the computer and the device. In this way, not only must an extra expense for the interface card be paid, but disassembling/assembling a computer is also time and effort consuming, and the whole process is thus rather inconvenient. After the appearance of the universal serial bus (USB) interface, any device, so long as it is in accordance with this specification, can be directly connected to a computer via this interface, thereby significantly enhancing the convenience of use of devices and computers, and further improving the expansion capability of computers.

The USB interface can be divided into a plug and a receptacle according to its utility. FIGS. 1 and 2 are schematic views of the plug and receptacle of the USB interface respectively. Referring to FIGS. 1 and 2, generally, the plug 110 of the USB interface is mainly used in transmission lines (as shown in FIG. 1) or mounted on a small-sized electronic device 130, such as a flash drive or a portable MP3 player (as shown in FIG. 3). The receptacle 120 of the USB interface is mainly disposed in large-sized hosts.

The plug 110 or the receptacle 120 of the USB interface is provided with a housing 112, 122 and connector 114, 124 respectively. When the user wants to connect the electronic device 130 to the computer via the USB for exchanging data, the housing 112 and the connector 114 of the plug 110 must be inserted into the housing 124 of the receptacle 120, and the connector 114 must be electrically connected to the leads in the connector 124. A conventional method is to directly dispose the plug 110′ of the USB interface onto the electronic device 130, as shown in FIG. 3. When the user intends to transfer data, the electronic device 130 can be connected to the computer simply by inserting the plug 110′ of the electronic device 130 directly into the receptacle (not shown) of the computer, without any extra transmission lines being required, which is relatively convenient.

However, though the foregoing method can eliminate the inconvenience of carrying along and using transmission lines, but the fixed plug 110′ has restricted the electronic device 130 to be connected to a main body (not shown) with the receptacle 120. Therefore, data transmission cannot be achieved between electronic devices 130 with plugs 110′.

### SUMMARY OF THE INVENTION

An object of the present invention is to provide a universal serial bus (USB) connecting device, which can be converted into a plug or a receptacle according to the user's requirements, and which therefore is very convenient.

To achieve the above or other objects, the present invention provides a USB connecting device, which includes a first housing, a second housing, a connector, and four second pins. The second housing, disposed at one side of the first housing, has a first opening being located at one side of the second housing far from the first housing. The connector is movably inserted into the second housing and includes a substrate movably inserted in the second housing, and four first pins embedded in the substrate. The first pins are disposed at one end of the substrate adjacent to the first opening. Moreover, the four second pins are disposed within the second housing. Each second pin is electrically connected to the corresponding first pin respectively. When the connector is accommodated within the second housing, the connector and the second housing form a receptacle. When the connector is moved to protrude from the first opening, the connector and the second housing form a plug.

In one embodiment of the present invention, the above-mentioned connecting device further includes a circuit board disposed within the first housing, and the second pins are connected to a circuit of the circuit board.

In one embodiment of the present invention, the above-mentioned connecting device further includes a third pin disposed on the first or second housing, suitable for providing a signal to the circuit board so as to determine whether the connector and the second housing function as a plug or a receptacle.

In one embodiment of the present invention, the above-mentioned connecting device further includes a controller connected to the connector, suitable for driving the connector to move along a moving path, such that the connector will protrude from the first opening, or be accommodated within the second housing.

In one embodiment of the present invention, one surface of the first housing further has a second opening, and the controller is connected to the connector through the second opening.

In one embodiment of the present invention, the controller is a button, and the substrate is connected to the first housing via a spring.

In one embodiment of the present invention, the above-mentioned connecting device further includes a fixture disposed on the first housing for limiting the position of the connector.

In one embodiment of the present invention, the above-mentioned first and second housings are integrated as a whole.

The present invention further provides a USB connecting device, which includes a first housing, a second housing, a connector, and four second pins. The second housing, movably disposed at one side of the first housing, has a first opening being located at one side of the second housing far from the first housing. The connector is inserted in the second housing and includes a substrate inserted in the second housing, and four first pins embedded in the substrate. The first pins are disposed at one end of the substrate adjacent to the first opening. Moreover, the four second pins are disposed within the second housing. Each second pin is electrically connected to the corresponding first pin respectively. When the connector is accommodated within the second housing, the connector and the second housing form a receptacle. When the second housing is moved to make the connector protrude from the first opening, the connector and the second housing form a plug.

In one embodiment of the present invention, the above-mentioned connecting device further includes a circuit board disposed within the first housing, and the first pins are connected to a circuit of the circuit board.

In one embodiment of the present invention, the above-mentioned connecting device further includes a third pin disposed on the first or second housing, suitable for providing a signal to the circuit board so as to determine whether the connector and the second housing function as a plug or a receptacle.

In one embodiment of the present invention, the above-mentioned connecting device further includes a controller connected to the second housing, used for driving the second housing to move along a moving path, such that the connector will protrude from the first opening, or be accommodated within the second housing.

In one embodiment of the present invention, one surface of the first housing further has a second opening, and the controller is connected to the second housing through the second opening.

In one embodiment of the present invention, the above-mentioned USB connecting device further includes a spring connected between the first housing and the second housing. Besides, the controller is a button for limiting the position of the spring.

In one embodiment of the present invention, the above-mentioned connecting device further includes a fixture disposed on the first housing for limiting the position of the second housing.

As for the USB connecting device of the present invention, the user can select to use a plug or a receptacle according to different requirements by adjusting the relative position between the second housing and the connector of the USB connecting device. Therefore, the USB connecting device of the present invention is very convenient.

In order to make the aforementioned and other objects, features, and advantages of the present invention comprehensible, preferred embodiments accompanied with figures are described in detail below.

### BRIEF DESCRIPTION OF THE DRAWINGS

FIG. 1 is a schematic view of a plug of the USB interface.

FIG. 2 is a schematic view of a receptacle of the USB interface.

FIG. 3 is a schematic view of an electronic device built-in with the plug of the USB interface.

FIG. 4A is a schematic view of the USB connecting device according to a first embodiment of the present invention.

FIG. 4B is a cross-sectional view along the line A-A′ in FIG. 4A.

FIG. 4C is a cross-sectional view of the USB connecting device in FIG. 4A used as a plug.

FIG. 4D is a cross-sectional view of the USB connecting device in FIG. 4A used as an integrated plug.

FIG. 5A is a cross-sectional view of the USB connecting device used as a receptacle according to a second embodiment of the present invention.

FIG. 5B is a cross-sectional view of the USB connecting device in FIG. 5A used as a plug.

FIG. 6A is a cross-sectional view of the USB connecting device used as a receptacle according to a third embodiment of the present invention.

FIG. 6B is a cross-sectional view of the USB connecting device in FIG. 6A used as a plug.

FIG. 6C is a cross-sectional view of the USB connecting device in FIG. 6A used as an integrated plug.

FIG. 7A is a cross-sectional view of the USB connecting device used as a receptacle according to a fourth embodiment of the present invention.

FIG. 7B is a cross-sectional view of the USB connecting device in FIG. 7A used as a plug.

### DESCRIPTION OF EMBODIMENTS

### The First Embodiment

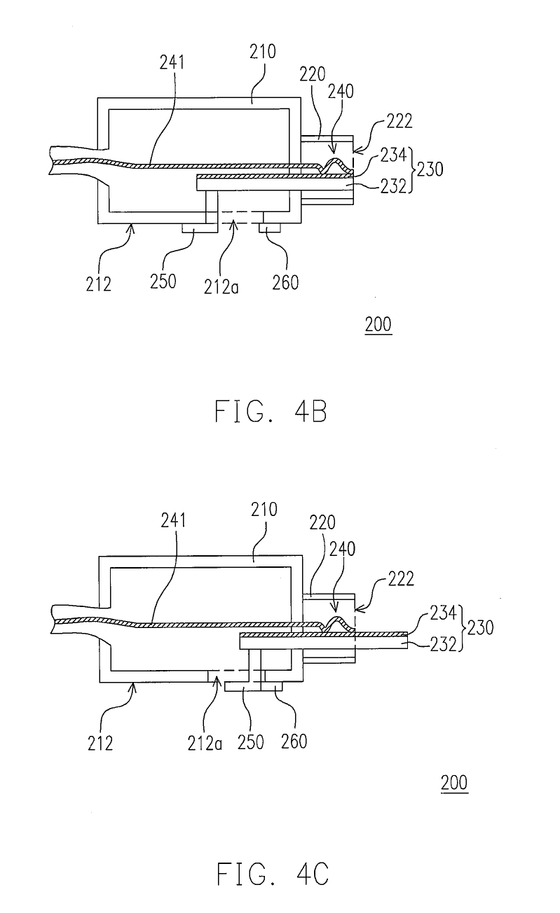

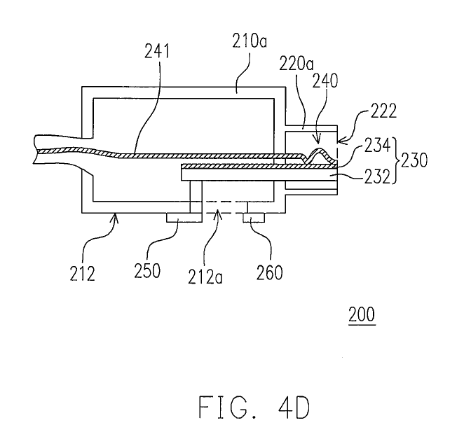

FIG. 4A is a schematic view of the USB connecting device according to a first embodiment of the present invention. FIG. 4B is a cross-sectional view of FIG. 4A along the line A-A′. Referring to FIGS. 4A and 4B, the USB connecting device 200 of this embodiment is a USB transmission line, which includes a first housing 210, a second housing 220, a connector 230, and four second pins 240. The second housing 220 is disposed at one side of the first housing 210, and has a first opening 222 being located at one side of the second housing 220 far from the first housing 210. The connector 230 includes a substrate 232 movably inserted in the second housing 220, and four first pins 234 embedded in the substrate 232. The first pins 234 are disposed at one end of the substrate 232 adjacent to the first opening 222. Moreover, the four second pins 240 are disposed within the second housing 220 and connected to the transmission line via a connecting line 241. Each second pin 240 is electrically connected to the corresponding first pin 234 respectively, i.e., one second pin is correspondingly connected to one first pin.

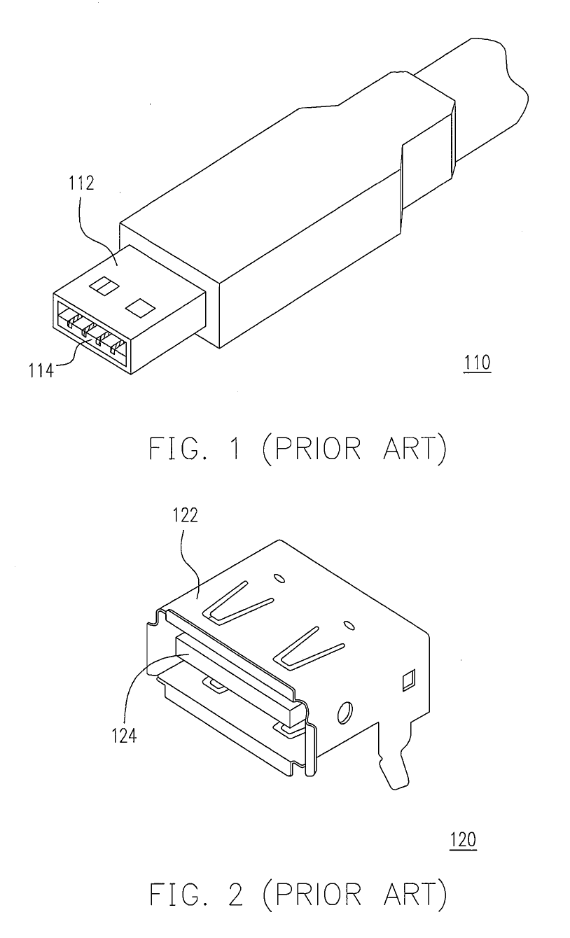

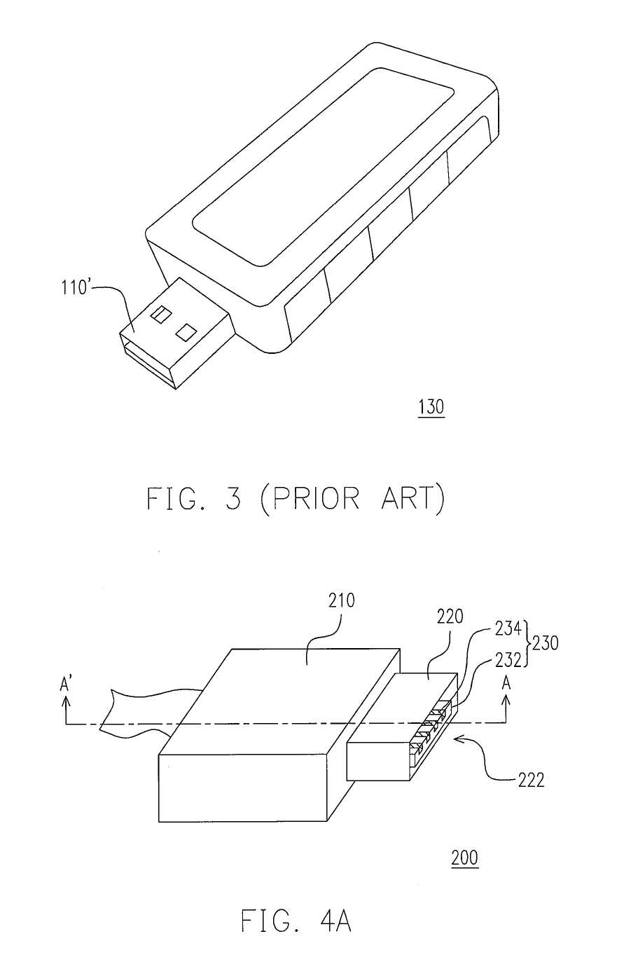

FIG. 4C is a cross-sectional view of the USB connecting device in FIG. 4A used as a plug. Referring to FIGS. 4B and 4C, when the connector 230 of this embodiment is accommodated within the second housing 220, the connector 230 and the second housing 220 form a receptacle (as shown in FIG. 4B), which can be used to accommodate other plugs (as shown in FIG. 1). Moreover, the substrate 232 can be movably inserted in the second housing 220. The user can make the connector 230 protrude from the first opening 222 to form a plug (as shown in FIG. 4C). Meanwhile, the USB connecting device 200 can be connected to the host (not shown) by inserting the plug into the receptacle (as shown in FIG. 2) of the host, so as to transmit data. As for the user, the USB connecting device 200 of this embodiment is convenient to use.

To facilitate the user to move the connector 230, the USB connecting device 200 further includes a controller 250, which can be a pushing key. A surface 212 of the first housing 210 has a second opening 212a. Through the second opening 212a, the controller 250 is directly connected to the substrate 232 of the connector 230. The second opening 212a provides a moving path for the controller 250; therefore, when pushing the controller 250, the connector 230 is driven to move along the moving path.

Furthermore, the USB connecting device 200 also includes a fixture 260 disposed on the first housing 210 for limiting the position of the connector 230.

Though the above-mentioned controller 250 is, e.g., a pushing key, the present invention is not limited to this. In another embodiment (not shown), the controller 250 is alternatively a button, and the substrate 232 is connected to the first housing 210 via a spring. When the connector 230 is accommodated within the second housing 220 to form a receptacle, the fixture 260 may limit the deformation of the spring. Meanwhile, the spring stores a restoring force. When the user intends to make the connector 230 protrude from the first opening 222 of the second housing 220 to form a plug, the restricting action of the fixture 260 to the spring can be released by pressing the controller 250. At this time, the spring releases the restoring force from being deformed, so as to push the substrate 232, thereby making the connector 230 protrude from the first opening 222 to form a plug.

Further, the second housing 220 is disposed at one side of the first housing 210 in this embodiment. However, as the spirit of the embodiment is to convert the USB connecting device 200 into a plug or a receptacle by moving the connector 230 without changing the relative position between the second housing 220 and the first housing 210, the first housing 210a also can be integrated with the second housing 220a in other embodiments, as shown in FIG. 4D.

In view of the above, when the USB connecting device 200 of this embodiment is employed, the USB connecting device 200 can be converted into a plug or a receptacle by making the connector 230 protrude from the first opening 222 or be accommodated within the second housing 220. Therefore, it is convenient for the user.

### The Second Embodiment

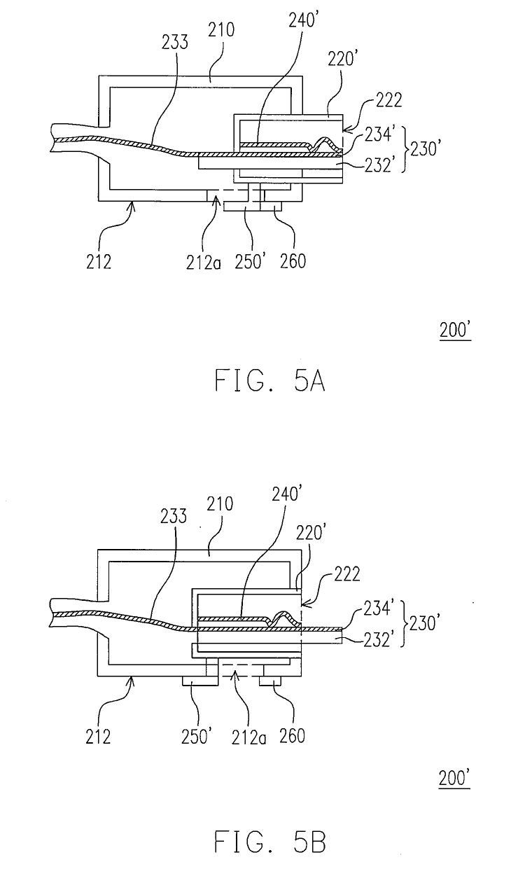

FIG. 5A is a cross-sectional view of the USB connecting device used as a receptacle according to a second embodiment of the present invention. In this embodiment and the first embodiment of the present invention, identical or similar reference numerals refer to identical or similar elements, which thus the description of those is omitted here.

Referring to FIGS. 4B and 5A, the difference between the first and second embodiments lies in that: the second housing 220 of the first embodiment is fixed on one side of the first housing 210, and in the first embodiment, the relative position between the connector 230 and the second housing 220 is changed by moving the connector 230, so as to make the USB connecting device 200 form a plug or a receptacle. The connector 230′ of the USB connecting device 200′ in this embodiment is fixed within the first housing 210. The second housing 220′ is movably disposed at one side of the first housing 210. And the first pins 234′ are connected to the transmission line via a connecting line 233. In other words, in this embodiment, the relative position between the connector 230′ and the second housing 220′ is changed by moving the second housing 220′, so as to make the USB connecting device 200′ form a plug or a receptacle.

FIG. 5B is a cross-sectional view of the USB connecting device in FIG. 5A used as a plug. Referring to FIGS. 5A and 5B, in this embodiment, once the second housing 220′ is pushed and moved, the second housing 220′ will be drawn back into the first housing 210, to make the connector 230′ protrude from the first opening 222. At this time, the connector 230′ and the second housing 220′ form a plug (as shown in FIG. 5B). When the second housing 220′ protrudes from the first housing 210 to cover and clad the connector 230′, the connector 230′ and the second housing 220′ form a receptacle (as shown in FIG. 5A).

Of course, to facilitate the user to move the connector 230′, similar to that illustrated in the first embodiment, a controller 250′ can be disposed in the USB connecting device 200′. It should be noted that the controller 250′ is connected to the second housing 220′, so the user can force the second housing 220′ to move along the moving path provided by the second opening 212a by pushing the controller 250′. Moreover, the USB connecting device 200′ further includes a fixture 260 disposed on the first housing 210 for limiting the position of the second housing 220′. In another embodiment (not shown), the controller 250′ can be a button, and the first housing 210 is connected to the second housing 220′ via a spring. When the connector 230′ protrudes from the second housing 220′ to form a plug, the fixture 260 may limit the deformation of the spring. Meanwhile, the spring stores a restoring force. When the user intends to make the connector 230′ be accommodated within the first opening 222 of the second housing 220′ to form a receptacle, the restricting action of the fixture 260 to the spring can be released by pressing the controller 250′. At this time, the spring will push the second housing 220′ by releasing the restoring force from being deformed, so as to make the connector 230′ be accommodated within the first opening 222 to form a receptacle.

In view of the above, when the USB connecting devices of the above two embodiments are employed, the relative position between the connector and the second housing can be adjusted according to different requirements, so as to determine whether the USB connecting device functions as a plug or a receptacle. Therefore, the USB connecting device of the present invention is very convenient for the user.

### The Third Embodiment

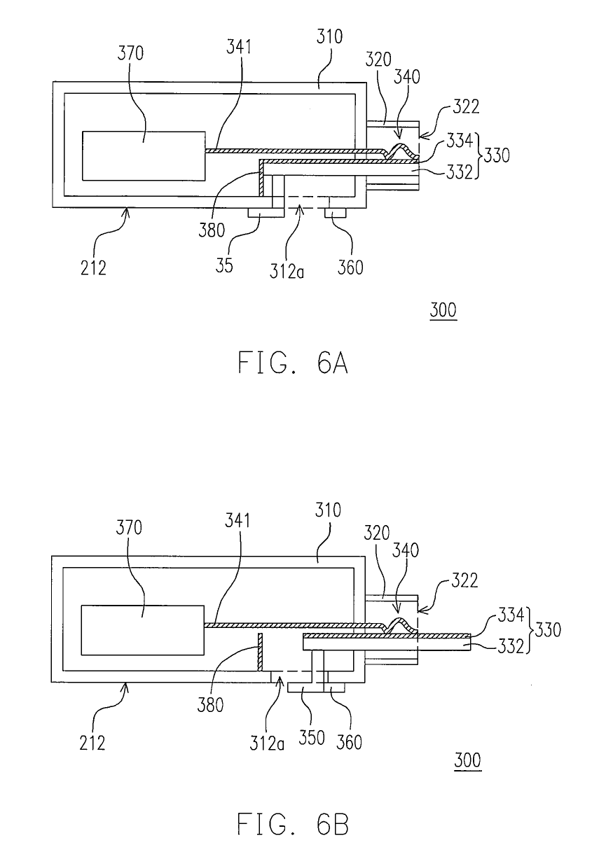

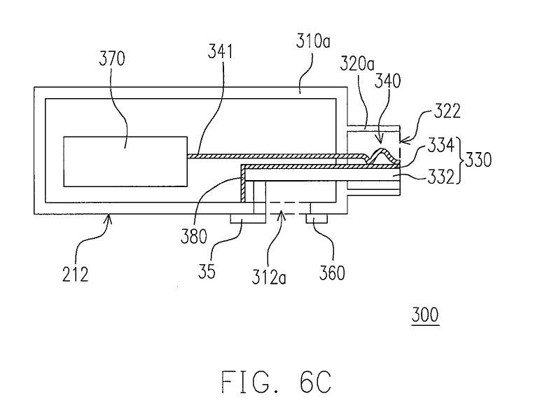

FIG. 6A is a cross-sectional view of the USB connecting device used as a receptacle according to a third embodiment of the present invention. Different from that of the first and second embodiments, the USB connecting device 300 of this embodiment is applied to an electronic device, such as a flash drive or a portable MP3 player.

Referring to FIG. 6A, the USB connecting device 300 of this embodiment includes a first housing 310, a second housing 320, a connector 330, four second pins 340, and a circuit board 370. The second housing 320 of this embodiment is fixed on lo one side of the first housing 310, and a first opening 322 is disposed at one side of the second housing 320 far from the first housing 310. In another embodiment, the second housing 320 also can be integrated with the first housing 310, as shown in FIG. 6C.

In view of the above, the connector 330 includes a substrate 332 movably inserted in the second housing 320, and four first pins 334 embedded in the substrate 332. Moreover, the circuit board 370 is disposed within the first housing 310. The second pins 340 are disposed within the second housing and connected to the circuit board 370 via a connecting line 341. Each of the second pins 340 is electrically connected to the corresponding first pin 334 respectively.

When the connector 330 of this embodiment is accommodated within the second housing 320, the USB connecting device 300 forms a receptacle. At this time, the USB connecting device 300 functions as a host. The receptacle formed by the connector 330 and the second housing 320 is used for being inserted by plugs disposed on other electronic devices to establish connections and to receive data transmitted from other electronic devices.

FIG. 6B is a cross-sectional view of the USB connecting device in FIG. 6A used as a plug. Referring to FIG. 6B, as the substrate 332 is movably inserted in the second housing 320, the user can make the connector 330 protrude from the first opening 322 by moving the substrate 332, such that the connector 330 and the second housing 320 form a plug. Meanwhile, the USB connecting device 300 can be connected to the computer host by inserting the plug into the receptacle (as shown in FIG. 2) of the computer host. As for the user, the relative position between the connector 330 and the second housing 320 can be adjusted according to various requirements, so as to enable the USB connecting device 300 to be connected to other electronic devices or hosts. Therefore, the USB connecting device 300 is very convenient.

Furthermore, the USB connecting device 300 further includes a third pin 380 selectively disposed on the first housing 310 or the second housing 320. The third pin 380 is suitable for providing a signal to the circuit board 300, to enable the circuit board 370 to determine whether the connector 330 and the second housing 320 form a plug or a receptacle according to the signal, thus outputting or receiving data accordingly. In this embodiment, the third pin 380 is used to generate signals by active detection or by being touched by the second housing 320. However, it is not limited herein, and the user can employ various mechanisms according to actual requirements, to enable the circuit board to determine whether the USB connecting device 300 functions as a plug or a receptacle.

Of course, to facilitate the user to push and move the substrate 332, the USB connecting device 300 can further include a controller 350 and a fixture 360. The arrangements, operation modes, and varied configurations of the controller 350 and the fixture 360 can be identical to that of the controller 250 and the fixture 260 in the first embodiment, and thus the description of those is omitted here.

### The Fourth Embodiment

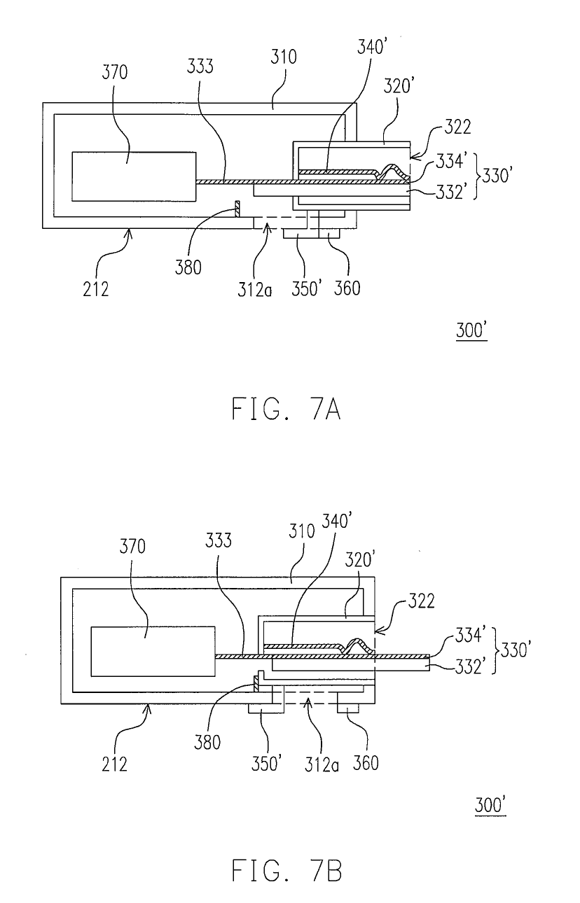

FIG. 7A is a cross-sectional view of the USB connecting device used as a receptacle according to a fourth embodiment of the present invention. The difference between the fourth embodiment and the third embodiment lies in that: the second housing 320 of the third embodiment is fixed on one side of the first housing 310, and in the third embodiment, the relative position between the connector 330 and the second housing 320 is changed by moving the connector 330, such that the connector 330 and the second housing 320 form a plug or a receptacle. In the USB connecting device 300′ of this embodiment, the connector 330′ is fixed within the first housing 310, and the first pins 334′ are connected to the circuit board 370 via a connecting line 333. The second housing 320′ is movably disposed at one side of the first housing 310. In other words, in this embodiment, the relative position between the connector 330′ and the second housing 320′ is changed by moving the second housing 320′, such that the USB connecting device forms a plug or a receptacle.

FIG. 7B is a cross-sectional view of the USB connecting device in FIG. 7A used as a plug. In particular, once the second housing 320′ is pushed and moved, the second housing 320′ is drawn back into the first housing 310, thereby forcing the connector 330′ to protrude from the first opening 322. At this time, the connector 330′ and the second housing 320′ form a plug (as shown in FIG. 7B). When the second housing 320′ protrudes from the first housing 310 to cover and clad the connector 330′, the connector 330′ and the second housing 320′ form a receptacle (as shown in FIG. 7A). Therefore, the user can determine whether the USB connecting device 300′ functions as a plug or a receptacle according to different requirements.

The same as that of the third embodiment, the USB connecting device 300′ also includes a third pin 380 disposed on the first housing 310. The position of the third pin 380 is not limited, and it can be selectively disposed on the first housing 310 or the second housing 320′ according to actual requirements. The function of the third pin 380 has been illustrated in detail in the above embodiments, which thus will not be repeated herein. Moreover, to facilitate the user to push and move the connector 330′, the USB connecting device 300 can further include a controller 350′ and a fixture 360. The arrangements, operation modes, and varied configurations of the controller 350 and the fixture 360 are identical to that of the controller 250 and the fixture 260, which thus the description of those is omitted here.

In view of the above, the USB connecting device of the present invention can function as a plug or a receptacle through adjusting the relative position between the second housing and the connector, such that the USB connecting device can be inserted into a computer host or enabling other electronic devices to be inserted there-in, so as to establish connections and transmit data. Therefore, the USB connecting device of the present invention is very convenient.

Though the present invention has been disclosed above by the embodiments, it is not intended to limit the invention. Anybody skilled in the art can make some modifications and variations without departing from the spirit and scope of the invention. Therefore, the protecting range of the invention falls in the appended claims.

What is claimed is:

1. A USB connecting device, comprising:
a first housing;
a second housing, movably disposed at one side of the first housing, wherein a first opening is located at one side of the second housing far from the first housing;
a connector, inserted in the second housing, comprising:
a substrate, inserted in the second housing;
four first pins, embedded in the substrate; and
four second pins, disposed within the second housing, wherein the second pins are electrically and correspondingly connected to the first pins respectively,
wherein when the connector is accommodated within the second housing, the connector and the second housing form a receptacle, and when the second housing is moved to make the connector protrude from the first opening, the connector and the second housing form a plug.

2. The USB connecting device as claimed in claim 1, further comprising:
a circuit board, disposed within the first housing, wherein the first pins are connected to a circuit of the circuit board.

3. The USB connecting device as claimed in claim 2, further comprising:
a third pin, disposed on the first housing or the second housing, suitable for providing a signal to the circuit board, so as to determine whether the connector and the second housing function as the plug or the receptacle.

4. The USB connecting device as claimed in claim 1, further comprising:
a controller, connected to the second housing, suitable for driving the second housing to move along a moving path, thereby making the connector protrude from the first opening or be accommodated within the second housing.

5. The USB connecting device as claimed in claim 4, wherein one surface of the first housing further has a second opening, and the controller is connected to the second housing through the second opening.

6. The USB connecting device as claimed in claim 4, wherein the controller is a button, and the first housing is connected to the second housing via a spring.

7. The USB connecting device as claimed in claim 1, further comprising:
a fixture, disposed on the first housing, suitable for limiting the position of the second housing.
